(19) United States
(12) Patent Application Publication
(10) Pub. No.: US 2010/0201788 A1
(43) Pub. Date: Aug. 12, 2010

(54) METHOD AND SYSTEM FOR MATING AN INFRARED STEREOSCOPIC DEVICE WITH A VIEWING DEVICE

(76) Inventors: David Yu-Li HO, Taipei (TW); Gerrit Ary SLAVENBURG, San Jose, CA (US); Andrei Victor RYLIN, Mountain View, CA (US)

Correspondence Address: PATTERSON & SHERIDAN, L.L.P., 3040 POST OAK BOULEVARD, SUITE 1500, HOUSTON, TX, 77056, US

(21) Appl. No.: 12/367,363

(22) Filed: Feb. 6, 2009

(51) Int. Cl. H04N 13/04; H04N 5/38

(52) U.S. Cl. 348/51; 348/723; 348/E05.093

(57) ABSTRACT

The present invention sets forth a method and system for mating a signal transmitting device and a viewing device. In one embodiment, the method includes determining presence of the signal transmitting device and the viewing device, selecting a unique code from a pre-determined group of codes assigned to the signal transmitting device, and sending the unique code to the viewing device for the viewing device to decipher data packets from the signal transmitting device.

### BACKGROUND OF THE INVENTION

1. Field of the Invention

The present invention relates in general to three-dimensional viewing. More particularly, the present invention relates to mating of an infrared stereoscopic device with an emitter which can be used by one or more viewers to obtain a 3D image.

2. Description of the Related Art

Various attempts have been made over the years to develop and implement methods and systems to represent scenes and objects in a manner which produces a sense of depth perception, known in the art as three dimensionality.

One particular system involves eyeglasses worn by the viewer and employing a switching mechanisms capable of sequential rapid on/off switching of optical elements. Various solutions have been provided to control the switching mechanism. One solution is to use an infrared stereoscope to emit infrared light to transmit a sequence of on and off signals to the glasses. A series of control signals in a specific sequence is transmitted by the infrared stereoscope from an emitter coupled to a projector to a receiver coupled to a pair of 3D-glasses. The sequence of control signals for the switching mechanism is to coordinate with changes in the images being displayed, usually in such manner that the left image is displayed when the left eye's vision of the screen is enabled and the right eye's vision is blocked, and at a later time the right image is displayed when the right eye's vision is enabled and the left eye is blocked, wherein switching is intentionally rapid enough so that the persistence of human vision leaves the viewer with an impression of a continuous image. It should be noted that if switching had been slowed due to outside disruption, an impression of flickering would have resulted.

Currently, a pair of 3D-glasses is configured to receive one sequence of signals from one specific emitter of a projector in order to correctly display the 3D image. However, problems exist when a projector uses multiple emitters to transmit signals to multiple 3D-glasses. A first pair of 3D-glasses may pick up signals that are originally targeted for a second pair of 3D-glasses. The additional signals received by the first pair of 3D-glasses may cause interference to a sequence of signals that is indeed for the first pair of 3D-glasses, therefore causing flickering to the images.

As the foregoing illustrates, what is needed is a method and system capable of transmitting signals from an emitter to a matching viewing device while maintaining the sequence of signals that matches with the 3D images, and address at least the problems set forth above.

### SUMMARY OF THE INVENTION

One embodiment sets forth a method for mating a signal transmitting device and a viewing device. The method includes determining presence of the signal transmitting device and the viewing device, selecting a unique code from a pre-determined group of codes assigned to the signal transmitting device, and sending the unique code to the viewing device for the viewing device to decipher data packets from the signal transmitting device.

At least one advantage of the embodiment disclosed herein is to provide an efficient method to distinguish different signals emitted from different projectors and address at least the problems described above.

### BRIEF DESCRIPTION OF THE DRAWINGS

So that the manner in which the above recited features of the embodiment can be understood in detail, a more particular description of the invention, briefly summarized above, may be had by reference to implementations, some of which are illustrated in the appended drawings. It is to be noted, however, that the appended drawings illustrate only typical implementations of this invention and are therefore not to be considered limiting of its scope, for the invention may admit to other equally effective implementations.

FIG. 1A is a schematic diagram of a 3D image display system 100 implementing one or more aspects of the embodiment;

FIG. 1B is a simplified block diagram of the 3D image display system 100 as illustrated in FIG. 1A, according to one embodiment;

FIG. 2 is an example of a data packet, according to one embodiment; and

FIG. 3 is a flow chart describing a sequence for synchronizing an emitter of the host machine and a viewing device, according to one embodiment.

### DETAILED DESCRIPTION

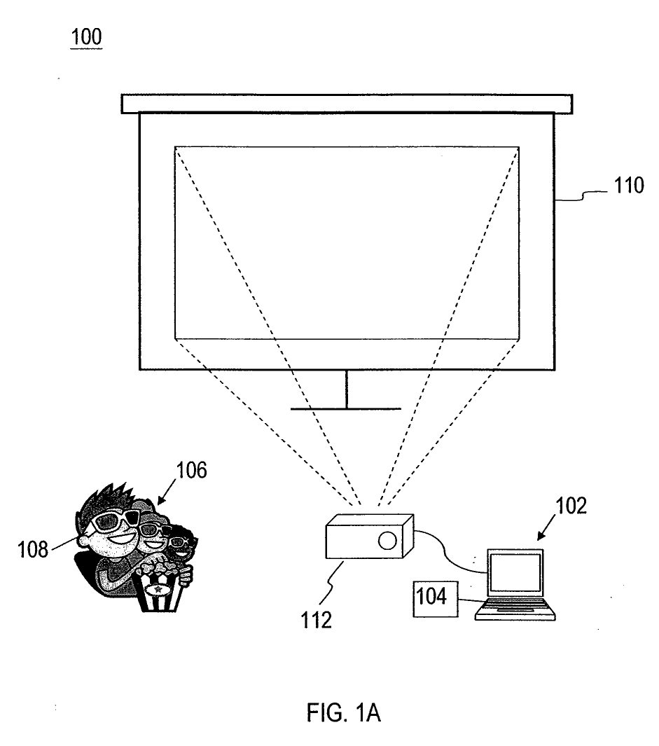

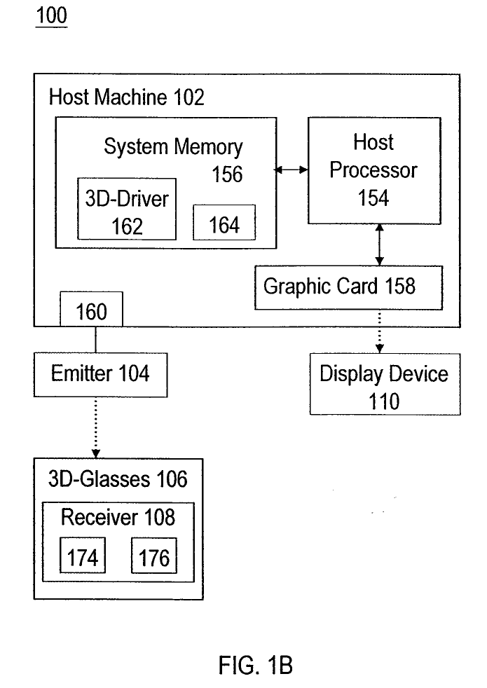

FIG. 1A is a schematic diagram of a 3D image display system 100 implementing one or more aspects of the embodiment. The system 100 includes a host machine 102 coupled with an emitter 104, a viewing device 106 coupled with a receiver 108, and a display device 110. The host machine 102 is configured to process an image data. The image data is to be displayed on the display device 110 through an image processing device 112 coupled to the host machine 102. The image processing device 112 may include a projector. The host machine 102 is further configured to transmit a data packet to the receiver 108. In one implementation, the data packet is transmitted by infrared light (IR) using an IR stereoscope through the emitter 104. The data packet is emitted from the emitter 104 to the receiver 108 coupled with the viewing device 106. The data packet may include a command for the receiver 106. In one implementation, the command may include an on/off command. The viewing device 106 is configured to process the data packet received by the receiver 108. The viewing device 106 is further configured to determine if the received data packet is the correct data packet for the viewing device 106. In one implementation, the viewing device 106 may be a 3D-glasses worn by a viewer. The 3D-glasses are equipped with lenses that can turn on or off and is controlled by the on/off command. To show the image data properly through the 3D-glasses for the 3D effect, the lenses are turned on and off in a particular sequence as the image data is shown on the display device 110. Specifically, when the image data is shown on the display device 110, the 3D-glasses receive and execute data packets containing the on/off commands so that the proper image and its 3D effect then can be shown to the viewer.

FIG. 1B is a simplified block diagram of the 3D image display system 100 as illustrated in FIG. 1A, according to one embodiment. The host machine 102 includes a host processor 154, system memory 156, a graphics card 158, and a bus interface 160. The emitter 104 is coupled to the host machine 102 through the bus interface 160. In one implementation, the bus interface 160 is a Universal Serial Bus (USB) interface. In another implementation, the emitter 104 is an infrared (IR) stereoscopic transmitter capable of emitting IR signals. The system memory 156 is a storage area storing program instructions or data such as, a driver 162 for displaying 3D images. The system memory 156 also includes memory block 164, which in one implementation is allocated to store unique codes to be distributed to the viewing devices 106. The graphics card 158 is configured to be the rendering engine for the 3D images. The 3D images are then shown on a display device 110. The viewing device 106 is coupled with a receiver 108. The receiver 108 includes a processor 174 configured to process signals and data packets sent by the emitter 104, and a storage area 176 capable of storing an unique code distributed by the host machine 152.

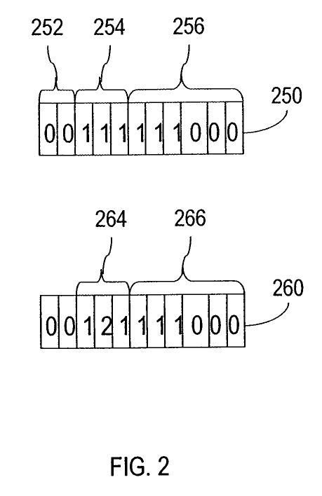

To better assist the viewing device 106 in receiving the correct data packet, the host machine 102, in one implementation, is further configured to place a unique code in the header of a data packet. The unique code may be determined by the host machine 102 and read and matched by the viewing device 106. The data packet may be configured to include any number of bits that the host machine 102 deems appropriate. An example of the data packet 250 with the unique code is shown in FIG. 2. The data packet 250 here is an 11-bit data packet. The data packet 250 may include several sections. A first section 252 contains address information for the emitter 104 of FIG. 1A, which sends out the data packet 250. Each emitter is assigned with its own address information. In the data packet 250, the first section 252 is a 2-bit data containing the address information of the emitter 104, for example, 00 is the address information for the emitter 104. A second section 254 contains the unique code information. Each unique code is separately placed into the header of the data packet by the host machine 102 and is unique to the viewing device 106 of FIG. 1A. The second section 254 of the data packet 250 is a 3-bit data containing the unique code for the viewing device 106, for example, 111 is the unique code for viewing device 106. The third section 256 is a 6-bit data containing information such as the on/off command to be processed by the viewing device 106. For example, 111000 is the on command for the left eye vision of the screen. When the receiver 108 receives the data packet 250 from the emitter 104, the processor 174 in the receiver 108 would read the first section 252 and the second section 254 of the data packet 250. If the processor 174 determines that the unique code in the second section 254 matches with a same unique code of the viewing device 106, the viewing device 106 would determine that the data packet is indeed the correct data packet for the viewing device 106, and the third section 256 then is processed and the left eye vision of the screen is turned on. As shown by another data packet 260, if the processor 174 determines that the unique code 264 of the data packet 260 does not match the unique code 254 of the viewing device 106, the viewing device 106 would determine that the data packet 260 is incorrect, and pass on the data packet 260. The third section 266 of data packet 260 then would not be read and processed.

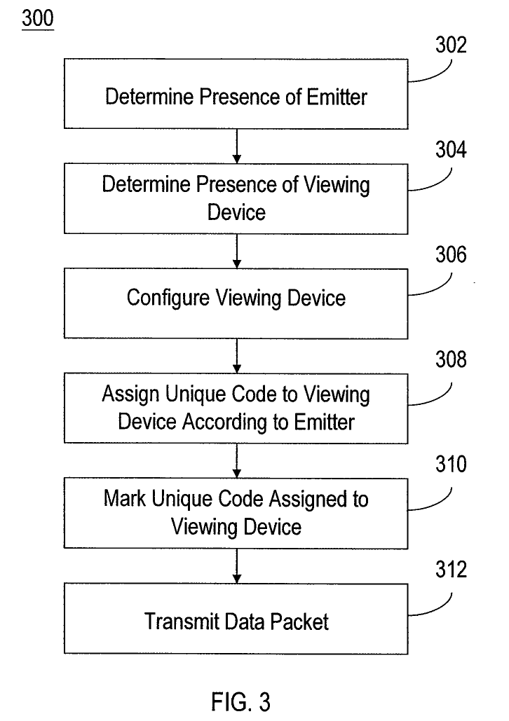

As discussed previously, before processing the data packet, the unique code of a viewing device should match up with the same unique code of a data packet. FIG. 3 is a flow chart describing a sequence for synchronizing an emitter of a host machine and a viewing device, according to one embodiment. To synchronize the emitter and the viewing device, both the emitter and the viewing device in one implementation are connected to the host machine at the same time. In step 302, the host machine determines the presence of the emitter. The host machine then determines the presence of the viewing device in step 304. When the presence for both the emitter and the viewing device are detected, in step 306, the synchronization sequence may begin by configuring the viewing device. In step 308, the host machine assigns a unique code to the viewing device. The unique code is selected from a pre-determined group of unique codes that are assigned to the emitter. It should be noted that the assignment of the unique codes to the emitter may be performed by a different host machine. This assignment information is then transferred to the host machine synchronizing the emitter and the viewing device. For multiple emitters, each emitter is assigned with its own group of unique codes. The number of unique codes assigned to the emitter may be pre-determined and/or adjustable. In one implementation, the number of unique codes assigned to the emitter can be adjusted by the host machine based on the number of available viewing devices that are configured to pair with the emitter. For examples, the emitter may be assigned five different unique codes, so that it can serve five different viewing devices. The host machine may adjust the number down to four, if the host machine determines that one of the five viewing devices becomes unavailable (e.g., going offline). In step 310, after assigning the unique codes to the viewing devices, the assigned unique codes are marked. The host machine as a result would be able to differentiate between the assigned unique codes from the unassigned unique codes. The unassigned unique codes would then be used during future pairing of additional viewing devices and emitters. Once a unique code is assigned and marked in the host machine, the host machine then can place the assigned unique code in a data packet and transmit the data packet in step 312.

Referring back to the example shown in FIG. 1A, before the viewing device 106 starts processing data packets, the viewing device 106 goes through the synchronizing sequence with the emitter 104 by connecting to the host machine 102 as illustrated in FIG. 3. In one implementation, the viewing device 106 may be connected to the host machine 102 via the Universal Serial Bus (USB) interface. During the first time when both the emitter 104 and the viewing device 106 are connected to the host machine 102 through the USB connection, when the host machine 102 detects the presence for both the emitter 104 and the viewing device 106, the unique code is then assigned to the viewing device 106. In one implementation, the unique code may be assigned automatically by the host machine 102, or the unique code may be assigned manually by a user through the host machine. Once the unique code is assigned to the viewing device 106, the synchronization sequence is complete. It is to be noted that the unique code of the viewing device 106 should work only with the emitter 104 that is connected during the synchronization. If another emitter is to be paired with the viewing device 106, then synchronization between the viewing device 106 and the new emitter would be performed again so that the viewing device 106 is assigned a different unique code.

When all viewing devices have obtained their respective unique codes, the viewing devices are configured to decipher the data packets with the matching unique codes. In one implementation, if a viewing device determines that the unique code does not match up, then the non-matching data packets are not processed. When a first viewing device can no longer decipher data packets targeted for a second viewing device, interference can now be reduced, and flickering to the image caused by the incorrect data packets may be reduced as well.

While the foregoing is directed to implementations of the embodiment, other and further implementations of the invention may be devised without departing from the basic scope thereof, and the scope thereof is determined by the claims that follow.

We claim:

1. A method for mating a signal transmitting device and a viewing device, comprising:
determining presence of the signal transmitting device and the viewing device;
selecting a unique code from a pre-determined group of codes assigned to the signal transmitting device; and
sending the unique code to the viewing device for the viewing device to decipher data packets from the signal transmitting device.

2. The method of claim 1, wherein the data packet includes at least an address information section, a unique code section, and a command section.

3. The method of claim 1, wherein the determining step is performed through a Universal Serial Bus interface.

4. The method of claim 1, wherein the signal transmitting device is an infrared stereoscope capable of emitting infrared light.

5. The method of claim 1, wherein the viewing device may include a pair of 3D-glasses.

6. The method of claim 2, wherein the command section may include an on/off command.

7. The method of claim 1, wherein the pre-determined group of codes is adjustable based on a number of viewing devices that is configured to pair with the signal transmitting device.

8. A system for providing a unique code from a host machine to a viewing device, comprising:
a viewing device coupled with a receiver; and
a host machine coupled with an emitter, comprising:
a system memory capable of storing program instructions or data;
a graphic card configured to render 3D-images;
a bus interface; and
a host processor configured to
determine presence of the emitter and the viewing device;
select a unique code from a pre-determined group of codes assigned to the emitter; and
send the unique code to the viewing device for the viewing device to decipher data packets from the signal transmitting device.

9. The system of claim 8, wherein the viewing device is a pair of 3D-glasses.

10. The system of claim 8, wherein the bus interface is a Universal Serial Bus (USB) interface.

11. The system of claim 8, wherein a number of unique codes is pre-determined for the emitter.

12. The system of claim 11, wherein the host processor is further configured to adjust the number of unique codes assigned to the emitter according to a number of viewing devices configured to pair with the emitter.

13. The system of claim 8, wherein the emitter is an infrared stereoscope capable of emitting infrared light.

14. The system of claim 8, wherein the viewing device may include a pair of 3D-glasses.

15. A viewing device, comprising:
a system memory capable of storing data;
a receiving unit configured to receive data packets; and
a processor configured to
receive a first unique code for pairing with an emitter;
storing the first unique code in the system memory; and
compare a second unique code extracted from a data packet to the first unique code stored in the system memory before deciphering the data packet.

16. The viewing device of claim 15, wherein the processor is further configured to process the data package if the second unique code matches the first unique code in the system memory.

17. The viewing device of claim 15, wherein the receiving unit is capable of receiving signals transmitted by infrared light.
